(19) United States
(12) Patent Application Publication
(10) Pub. No.: US 2004/0011180 A1
(43) Pub. Date: Jan. 22, 2004

(54) Methods and apparatuses for opening containers

(75) Inventor: Matthew L. Fourney, Laurel, MD (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Materials Handling Systems, Inc., Savage, MD

(21) Appl. No.: 10/198,330

(22) Filed: Jul. 16, 2002

(51) Int. Cl. B26D 1/00

(52) U.S. Cl. 83/651

(57) ABSTRACT

A container opening machine is disclosed. In one embodiment, the machine comprises a clamping mechanism that is configured to firmly clamp at least one container, the clamping mechanism being positionable in open and closed positions, and a cutting mechanism that is configured to cut the at least one container open while the at least one container is clamped by the clamping mechanism.

### FIELD OF THE DISCLOSURE

The present disclosure relates generally to container opening for purposes of container inspection. More particularly, the present disclosure relates to methods and apparatuses for opening containers such that the interiors of the containers can be easily inspected.

### BACKGROUND

Various containers are used to distribute non-carbonated soft drinks such as juices. One such container is the so-called juice box. Juice boxes typically comprise a semi-rigid, rectilinear box constructed of a laminate material that is typically composed of foil, paper, and plastic layers. This material is folded in various predetermined places and sealed along a longitudinal seam to form a finished box.

For purposes of quality control, it is common practice to inspect the seams of sample boxes during production, particularly after the box media (e.g., laminate material) are changed. One key aspect of this inspection is the inspection of the longitudinal seam. In that this seam is typically formed within the interior of the box, the boxes must normally be opened to determine the integrity of the seams.

Under current practices, quality control personnel manually remove filled juice boxes, manually cut the boxes open with a knife to both drain their contents and reveal the interior seam, rinse the boxes, allow the boxes to dry, and then visually inspect the seams for their integrity.

As can be appreciated from the process described above, various drawbacks are associated with the present inspection procedure. For one, the procedure is highly inefficient in that a human being must manually cut and clean each juice box, as well as wait for the boxes to dry. In addition, the process is potentially hazardous to the worker in that a knife, such as a standard box cutter, must be used to open the boxes.

From the foregoing, it can be appreciated that it would be desirable to have a system and method for automating the box opening procedure to facilitate inspection.

### SUMMARY

The present disclosure relates to container opening. To this end, a container opening machine is disclosed. In one embodiment, the machine comprises a clamping mechanism that is configured to firmly clamp at least one container, the clamping mechanism being positionable in open and closed positions, and a cutting mechanism that is configured to cut the at least one container open while the at least one container is clamped by the clamping mechanism.

### BRIEF DESCRIPTION OF THE DRAWINGS

The components in the following drawings are not necessarily to scale, emphasis instead being placed upon clearly illustrating the principles of the invention.

FIG. 1 is a side view of a container opening machine.

FIG. 2 is a plan view of the container opening machine of FIG. 1.

FIGS. 3A and 3B provide a flow diagram of an example of operation of the container opening machine of FIGS. 1 and 2.

FIG. 4 is a partial plan view of the container opening machine of FIGS. 1 and 2, illustrating diversion of containers from a line conveyor to a container opening machine conveyor.

FIG. 5 is a first perspective view of a container clamping mechanism of the container opening machine of FIGS. 1 and 2.

FIG. 6 is a second perspective view of the container clamping mechanism shown in FIG. 5.

FIG. 7 is a side view of a container being clamped by the clamping mechanism shown in FIGS. 5 and 6 and being cut by the cutting mechanism shown in FIG. 1.

FIG. 8 is a partial side view of the container opening machine of FIGS. 1 and 2, illustrating pivoting of a container opening apparatus of the machine.

FIG. 9 is a partial side view of the container opening machine of FIGS. 1 and 2, illustrating opening of a container using the container opening apparatus.

FIG. 10 is a partial side view of a container cleaning apparatus of the container opening machine of FIGS. 1 and 2, illustrating cleaning of a container.

FIG. 11 is a partial side view of the container opening machine of FIGS. 1 and 2, illustrating deposition of opened containers in a container collection tray of the machine.

### DETAILED DESCRIPTION

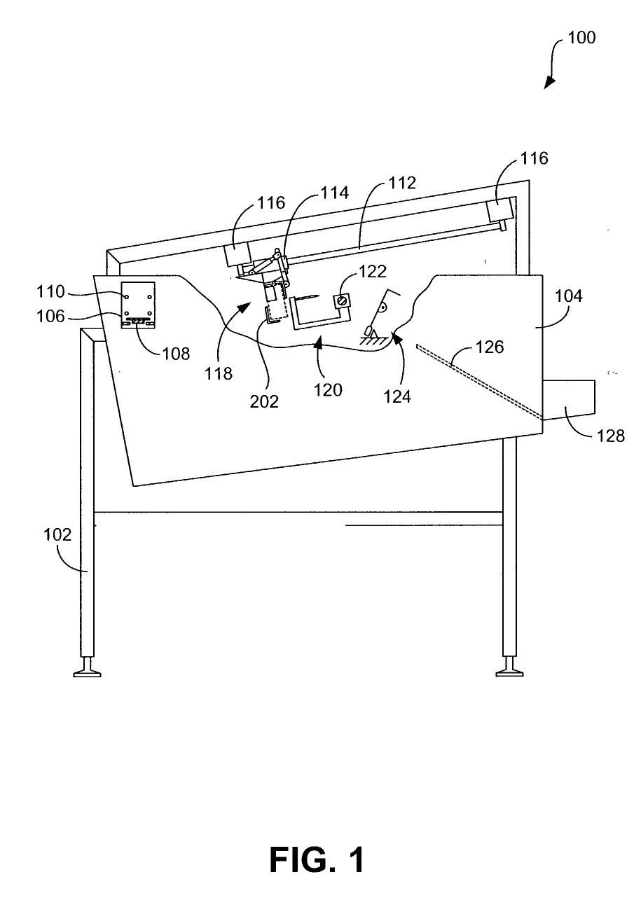

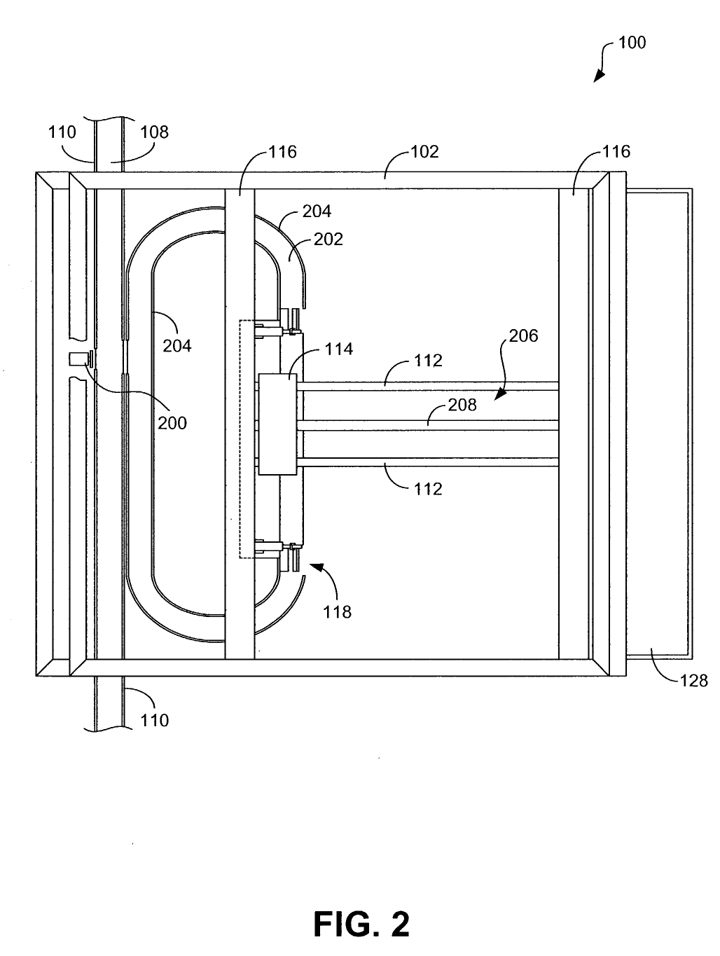

Referring now in more detail to the drawings, in which like numerals indicate corresponding parts throughout the several views, FIGS. 1 and 2 illustrate an example embodiment of a container opening machine 100. As indicated in FIG. 1, the container opening machine 100 generally comprises a frame 102 which can be enclosed by one or more exterior panels 104, one such panel being shown in partial cut-away. The illustrated exterior panel 104 can include a line conveyor opening 106 that is adapted to permit passage of a line conveyor 108 that forms part of a main line used to route containers after filling. As shown in the figure, the line conveyor 108 may include guide rails 110 that provide support to the containers while travelling on the conveyor.

As is illustrated in both FIGS. 1 and 2, the container opening machine 100 can include rails 112 along which an axially displaceable carriage 114 can travel. The rails 112 are mounted to the machine frame 102 with rail supports 116. Fixedly mounted to the carriage 114 is a container clamping mechanism 118 that is described in greater detail below.

Also included in the container opening machine 100 is a container cutting mechanism 120 (only shown in FIG. 1) that, as is discussed in greater detail below, is used to cut the containers open so that their interiors can be inspected. The container cutting mechanism 120 can be configured to travel along its own rail 122 in a direction out of and into the page in FIG. 1 (top to bottom and vice versa in FIG. 2). In addition to the cutting mechanism 120, a container opening apparatus 124 is provided that is used to that open cut containers so that their contents can be drained and their interiors rinsed and dried. Also shown in FIG. 1 is a collection tray ramp 126 which leads to a container collection tray 128 in which opened and cleaned containers are deposited for inspection by a qualified container inspector.

With particular reference to FIG. 2, the container opening machine 100 can further include a container ejector 200 that is used to eject containers from the line conveyor 108 to a container opening machine conveyor 202. As with the line conveyor 108, the machine conveyor 202 can include guide rails 204 that prevent the containers from falling off of the conveyor. In addition, the machine 100 includes a carriage displacement mechanism 206 that can include, for example, a pneumatic cylinder 208. Operation of the displacement mechanism 206 is described below.

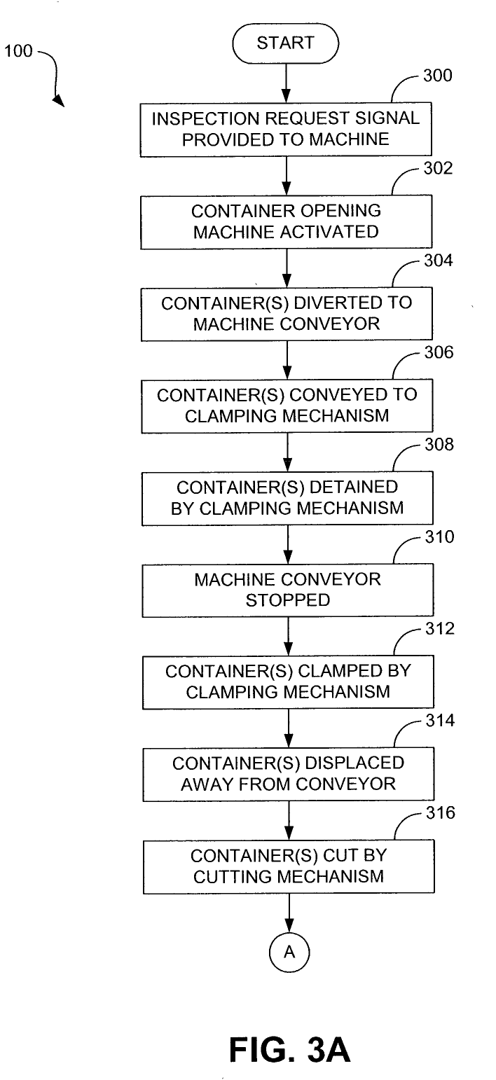

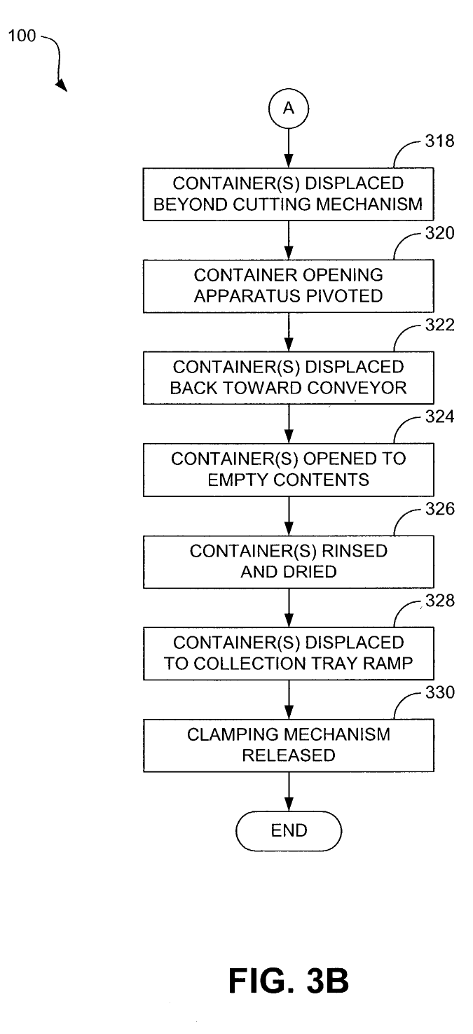

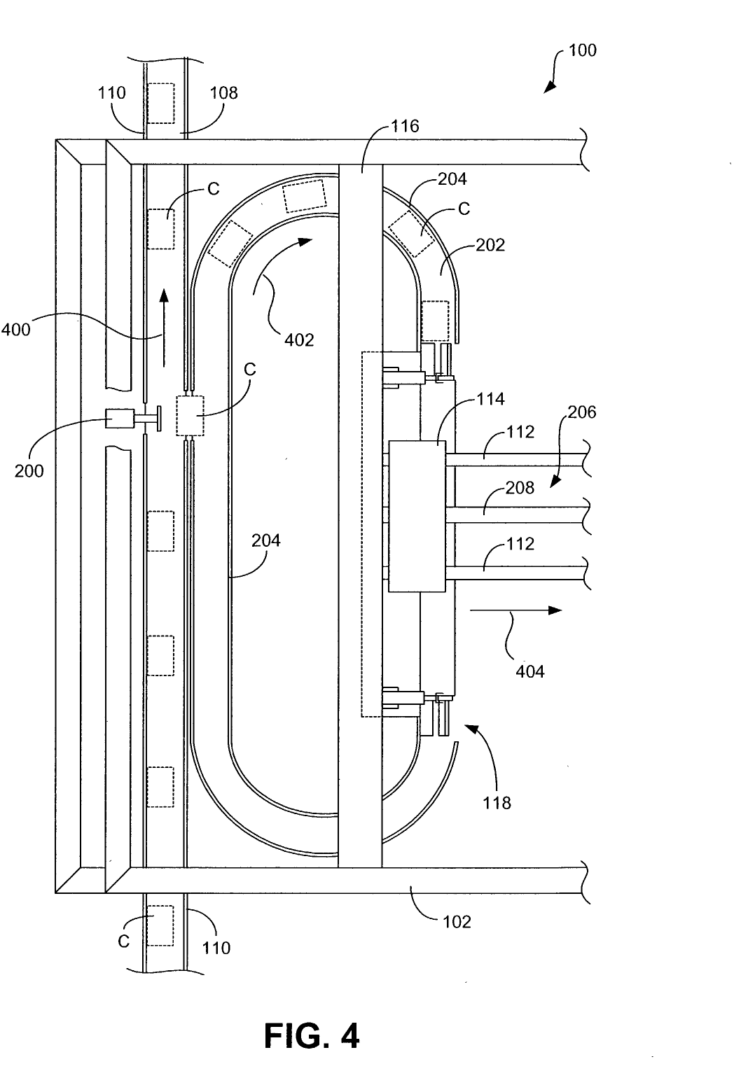

FIGS. 3A and 3B provide a flow diagram of an example of operation of the container opening machine 100. Through the discussion of this example and from FIGS. 4-11 that are referenced during the discussion, the nature and operation of the various machine components will become apparent, as will the overall operation of the machine 100. Although specific steps and operations are identified in the various blocks of the flow diagram, it is to be understood that one or more of these steps or operations can be combined, if desired, and that one or more steps/operations could be performed out of the sequence illustrated in FIGS. 3A and 3B.

Beginning with block 300 of FIG. 3A, a container inspection request signal is provided to the container opening machine 100. This signal can be provided to the machine 100 each time the container media (e.g., laminate material) are changed, on a periodic basis (e.g., once every fifteen minutes of active line operation), or any other time it is desired to inspect one or more containers. When this signal is provided to the container opening machine 100, the machine is activated, as indicated in block 302. Normally, such activation comprises powering up of the machine 100 such that the machine conveyor 202 begins to run and all other machine components are placed on stand-by for operation.

Once the container opening machine 100 is activated in this manner, one or more containers can be diverted from the line conveyor 108 to the machine conveyor 202, as indicated in block 304. For purposes of discussion, it will be assumed that more than one container is diverted in this manner. With reference to FIG. 4, each container C (e.g., juice box) can be diverted from the line conveyor 108 while travelling down the line in the direction indicated by arrow 400 (from bottom to top in FIG. 4) to the machine conveyor 202 using the container ejector 200. This ejector 200 can, for example, comprise a solenoid operated actuator that, as indicated in FIG. 4, pushes individual containers C across the line conveyor 108, through an opening in the line conveyor rails 110 and the machine conveyor rails 204, and onto the machine conveyor 202. Such actuation can, for instance, occur in response to sensing the presence of a container C using a photo eye (not shown) or other appropriate sensing device. As will be apparent to persons having ordinary skill in the art, other mechanisms could be used to divert the containers C in this manner such as a mechanical lever, blast of air, etc. To ensure correct positioning of the containers C on the machine conveyor 202 and to prevent the containers from bouncing off of the inner guide rail 204 after being diverted by the ejector 200, the machine conveyor can be tilted inwardly (see FIG. 1).

With reference back to FIG. 3A, after the containers C have been diverted to the machine conveyor 202 in the manner described above, the containers are conveyed to the container clamping mechanism 118, as indicated in block 306. As illustrated in FIG. 4, this can be achieved by conveying the containers C through 180 degrees in the direction indicated by arrow 402 (clockwise in FIG. 4). Although particular directions of travel have been identified, it is to be understood that they are provided for purposes of example only. It will be appreciated that the same functionality can be obtained irrespective of these directions.

Returning to FIG. 3A and block 308, the containers C are detained by the container clamping mechanism 118 such that the containers can no longer travel along with the machine conveyor 202. This detainment is illustrated in FIG. 6. As indicated in this figure, travel of the leading container C is limited by a stop 600 that, for example, comprises an integral part of the container clamping mechanism 118. Next, with reference to block 310 of FIG. 3A, the machine conveyor 202 is stopped. At this point, the containers C can be clamped by the container clamping mechanism 118, as indicated in block 312.

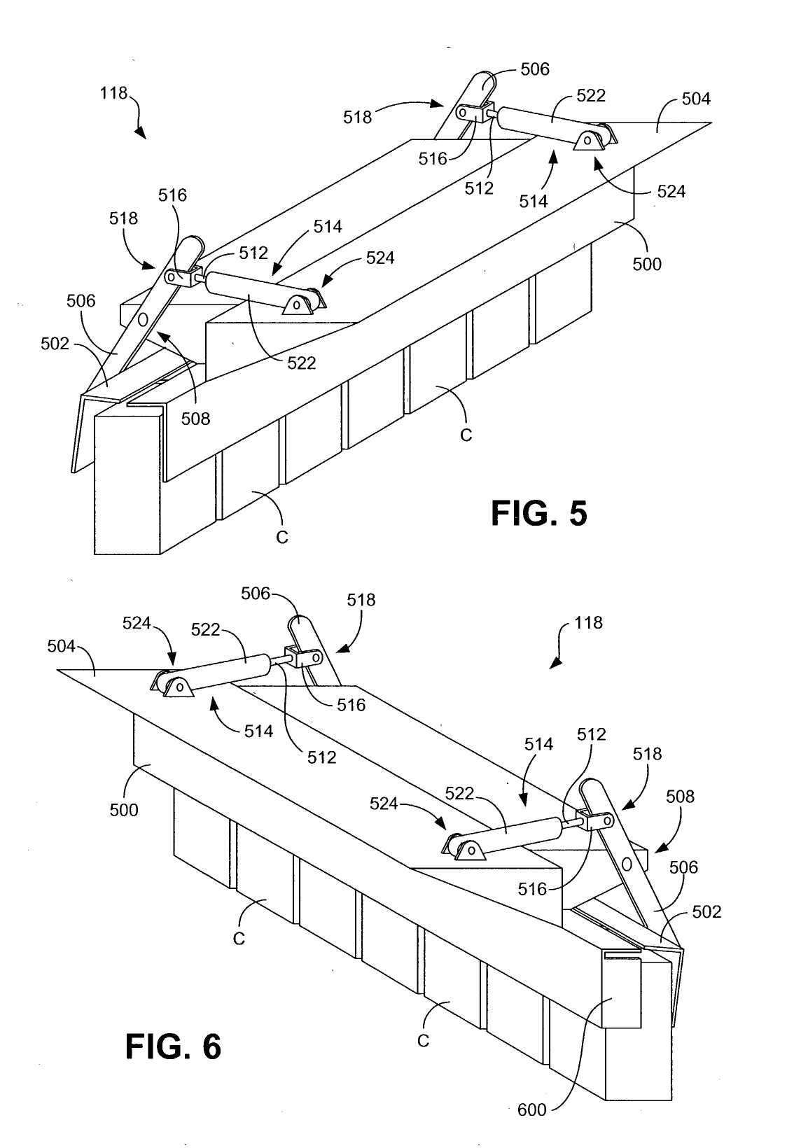

Clamping of the containers C is illustrated in FIGS. 5 and 6. In particular, FIG. 5 illustrates (from the perspective of a first end) the container clamping mechanism 118 while in an open position, and FIG. 6 illustrates (from the perspective of a second end) the container clamping mechanism while in a closed or clamped position. As shown in these figures, the container clamping mechanism 118 can include a first clamping member 500 and a second clamping member 502. The first clamping member 500 can be fixed to a body 504 of the clamping mechanism 118 so as to be stationary relative to the body. The second clamping member 502, however, can be pivotable so that it can be displaced toward and away from the first clamping member 500 in similar manner to a clam shell. As shown in the figures, the second clamping member 502 can be mounted (fixedly or pivotally) to levers 506 that are pivotally connected to the clamping mechanism body 504 at pivot points 508. By way of example, each lever 506 can be connected to the mechanism body 504 at the pivot point 508 with a pin or other suitable fastener.

The second end of each lever 506 can be pivotally connected to a piston rod 512 of a clamping member actuator 514. In particular, each lever 506 can be pivotally connected to a coupling member 516 of a piston rod 512 at a second pivot point 518 with a second pin or other suitable fastener. Each actuator 514 can comprise a pneumatic or hydraulic cylinder 522 that is pivotally mounted to the clamping mechanism body 504 at a further pivot point 524 with a further pin or other suitable fastener.

During operation, the containers C are conveyed through the first end of the container clamping mechanism 118 (FIG. 5) while the second clamping member 502 is in the open position (i.e. with the piston rods 512 of actuators 514 retracted). The containers C continue travelling through the open clamping mechanism 118 along the machine conveyor 202 until the lead container abuts against the stop 600 at the second end of the mechanism (FIG. 6). At this point, the second clamping member 502 can be closed toward the first clamping member 500 to clamp the containers C. By way of example, closing of the second clamping member 502 can be initiated after the expiration of a given period of time after the last container C of the group has been diverted on to the machine conveyor 202. Alternatively, a sensor (not shown) can be used to determine when to clamp down on the containers C. Clamping is achieved by extending the piston rods 512 of the clamping member actuators 514 so as to cause the levers 506 to pivot about pivot points 508 and, thereby, pivot the second clamping member 502 toward the first clamping member 500 until, as indicated in FIG. 6, firm contact is made with the containers C.

Returning again to FIG. 3A, the containers C can next be displaced away from the machine conveyor 202, as indicated in block 314, in a direction normal to the conveyor. Although this step is not necessarily required, it is preferable to avoid spillage of container contents directly upon the machine conveyor 202. This displacement can be achieved by displacing the entire container clamping mechanism 118 along the rails 112 in the direction of arrow 404 identified in FIG. 4. This can, in turn, be accomplished through use of the carriage displacement mechanism 206. In particular, the carriage displacement mechanism 206 is adapted to displace the axially displaceable carriage 114 along the rails 112. Such displacement results in similar displacement of the container clamping mechanism 118 in that the mechanism is fixedly connected to the carriage.

By way of example, the carriage displacement mechanism 206 comprises an internal magnetic piston (not shown) that is disposed within the cylinder 208 and which is magnetically coupled to a magnetic member (not show) that comprises part of the carriage 114. In such an arrangement, pressurized gas (e.g., air) can be delivered to either end of the cylinder 208 so as to cause the internal magnetic piston to travel in either direction along the cylinder. In that the piston is magnetically coupled to the magnetic member of the carriage 114, the carriage (and therefore the clamping mechanism 118) will likewise travel along the cylinder. Persons having ordinary skill in the art will appreciate that other mechanisms could be used to displace the carriage 114 such as an extendible and retractable cylinder similar to cylinders 522 of the clamping mechanism.

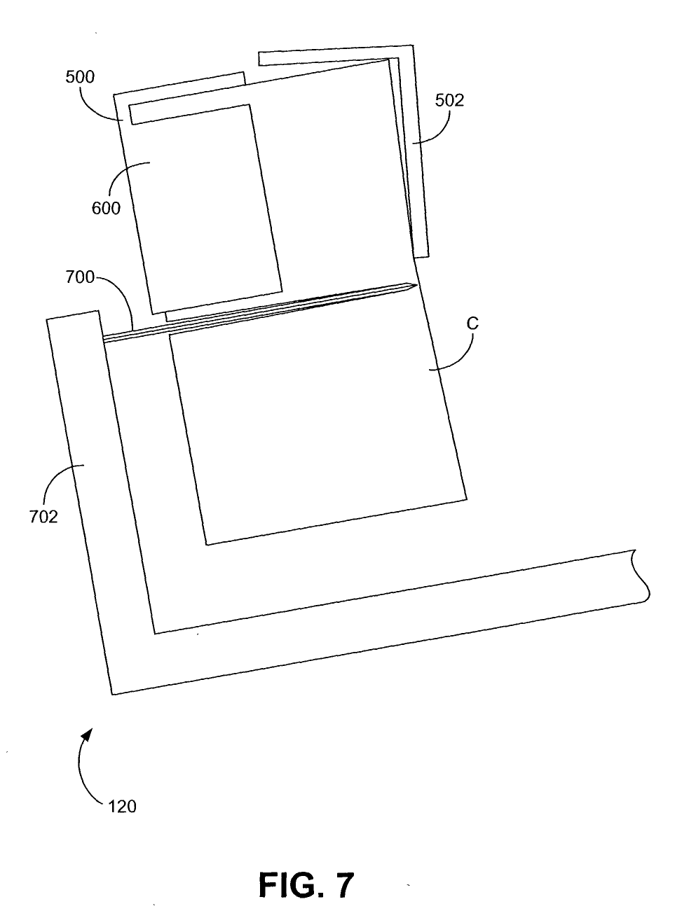

With reference back to FIG. 3A, the containers C are then cut open, as indicated in block 316. This step can be achieved using the container cutting mechanism 120 first identified in FIG. 1. Cutting of the containers C with the cutting mechanism 120 is schematically illustrated in FIG. 7. As indicated in this figure, the containers C can be suspended using the container clamping mechanism 118. The clamping mechanism 118 can be dimensioned such that only a top portion (e.g., half) of the container C is actually clamped, thereby exposing a bottom portion (e.g., half) of the container. In such an arrangement, the containers C can be cut approximately in half using a blade 700 of the cutting mechanism. The blade 700 can extend outwardly from an armature 702 of the cutting mechanism so as to transversely slice the containers C into nearly two separate pieces. As is discussed below, this degree of cutting both facilitates draining and cleaning of the containers C as well as inspection of their interiors.

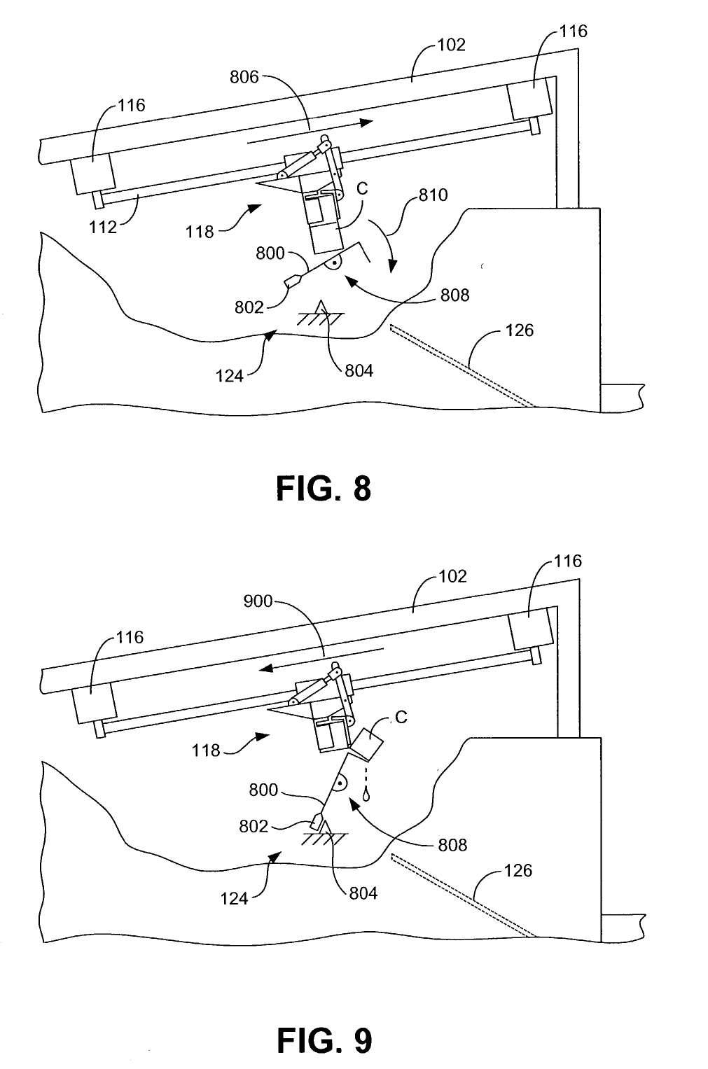

Turning now to FIG. 3B, the freshly cut containers C can be displaced beyond the cutting mechanism 120 in a direction away from the machine conveyor 202, as indicated in block 318, so as to pivot the container opening apparatus 124, as indicated in block 320. Such pivoting of this apparatus 124 is schematically illustrated in FIG. 8. As shown in FIG. 8, the opening apparatus 124 can comprise an elongated (in the direction into the page) fence 800 that comprises one or more counterweights 802 that normally rest against a stop 804. Axial displacement of the clamping mechanism 118 in the direction of arrow 806 causes the fence 800 to pivot about a central axis 808 of the fence (indicated by arrow 810) such that the counterweights 802 are lifted away from the stop 804.

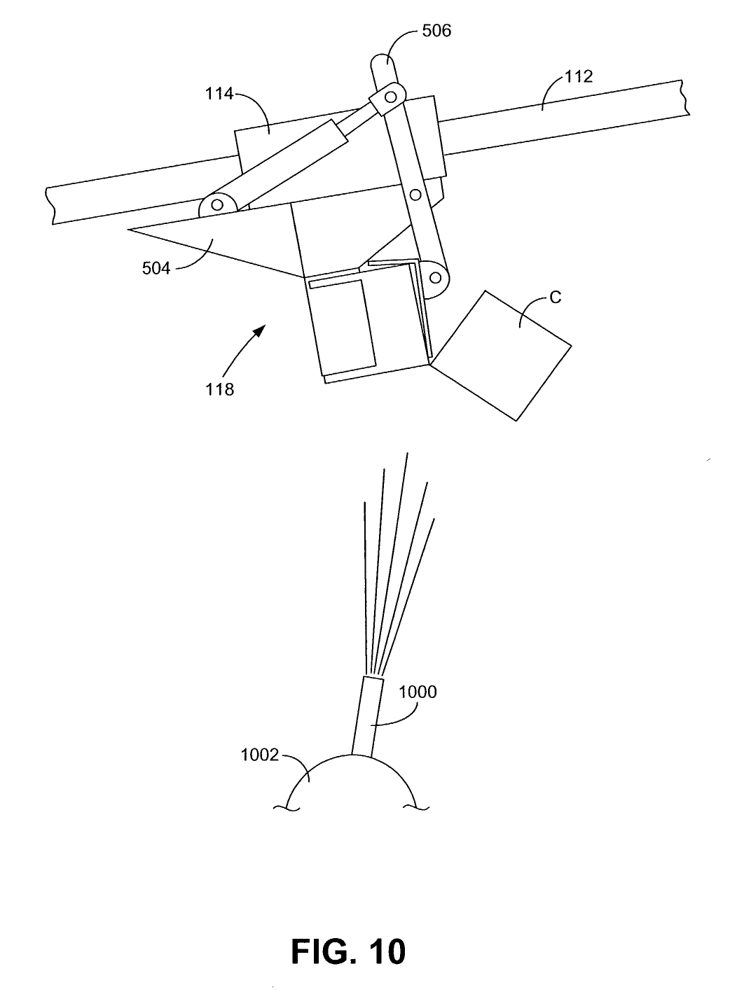

After the clamping mechanism 118 passes the container pivoting apparatus 124, the fence 800 returns to its initial position under the force of the counterweights 802. The clamping mechanism 118 is then displaced back toward the machine conveyor 202, as indicated in 322 (FIG. 3B) and illustrated by arrow 900 in FIG. 9. This action causes the cut containers C to be pivoted open by the fence 800 in the manner illustrated in FIG. 9. As shown in this figure, the bottom portion (e.g., half) of the containers C can be pivoted nearly through 180 degrees such that the containers can be emptied of their liquid contents, as indicated in block 324 (FIG. 3B).

With reference to block 326 of FIG. 3B, the containers C can next be rinsed and dried. These steps are schematically illustrated in FIG. 10. As indicated in this figure, the opened (pivoted) containers C can first be flushed with water using one or more nozzles 1000 that are connected to a feed line 1002. After flushing the containers C with water for a few seconds, jets of air can be delivered to the containers using the same nozzles 1000 to remove most of the water and thereby dry the containers.

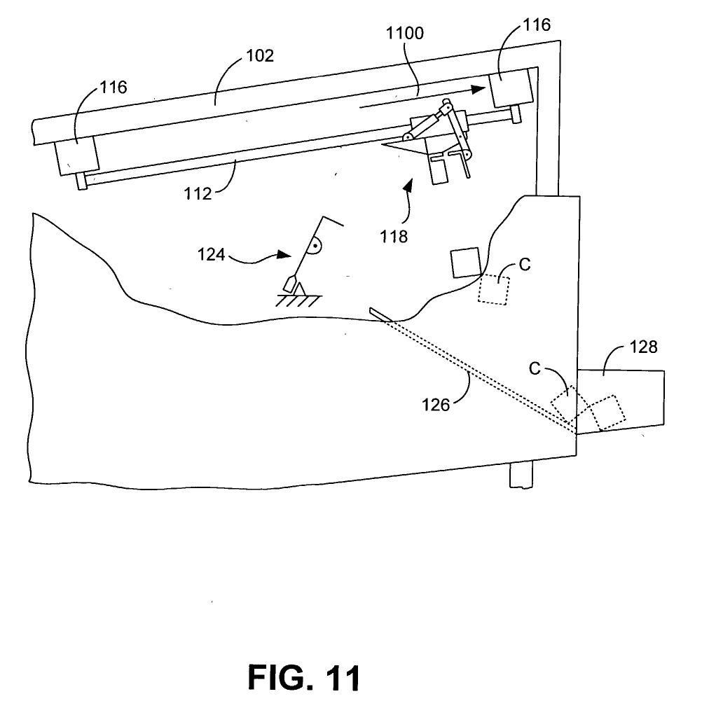

From this point, the containers C can be displaced further outward from the machine conveyor 202 as illustrated by arrow 1100 in FIG. 11 so as to be positioned above the collection tray ramp 126, as indicated in block 328. At this point, the clamping mechanism 118 can be opened, as indicated in block 330, and the containers C can be dropped as schematically illustrated in FIG. 11, so as to deliver the opened, flushed, and dried containers to the box collection tray 128. At this point, the containers C can be inspected by an appropriate inspector. By way of example, the inspector can inspect the internal, longitudinal seam of the containers C for their integrity. In that the containers C have been cut nearly in two pieces and bent backwards upon themselves, the inspector need only pick the containers up and look at their interiors to inspect them.

While preferred embodiments of the invention have been disclosed in detail in the foregoing description and drawings, it will be understood by those skilled in the art that variations and modifications thereof can be made without departing from the spirit and scope of the invention as set forth in the following claims.

1. A container opening machine, comprising:
a clamping mechanism that is configured to firmly clamp at least one container, the clamping mechanism being positionable in open and closed positions; and
a cutting mechanism that is configured to cut the at least one container open while the at least one container is clamped by the clamping mechanism.

2. The machine of claim 1, wherein the clamping mechanism is configured to firmly clamp a plurality of containers.

3. The machine of claim 2, wherein the clamping mechanism is configured to firmly clamp a plurality of box containers.

4. The machine of claim 1, wherein the clamping mechanism comprises a stationary clamping member and a pivotable clamping member, the pivotable clamping member being pivotable toward and away from the stationary clamping member.

5. The machine of claim 4, further comprising at least one actuator that pivots the pivotable clamping member.

6. The machine of claim 5, wherein the at least one actuator comprises a cylinder and a piston rod that can be extended from and retracted into the cylinder.

7. The machine of claim 5, further comprising at least one lever that links the at least one actuator to the pivotable clamping member

8. The machine of claim 7, further comprising a clamping mechanism body, the at least one actuator and the at least one lever being pivotally mounted to the body.

9. The machine of claim 1, wherein the cutting mechanism comprises an armature and a blade that extends from the armature, the blade being oriented so as to cut the container in a transverse direction.

10. The machine of claim 9, wherein the at least one container comprises at least one box container and the blade is oriented so as to transversely cut the at least one box container approximately in half.

11. The machine of claim 1, further comprising a carriage and at least one rail along which the carriage can travel, the clamping mechanism being fixedly mounted to the carriage so as to travel with the carriage along the at least one rail.

12. The machine of claim 11, further comprising a displacement mechanism that is configured to displace the carriage along the at least one rail.

13. The machine of claim 12, wherein the displacement mechanism comprises a cylinder having an internal magnetic piston that is magnetically coupled to the carriage such that when the piston is displaced within the cylinder under the force of a fluid, the piston and carriage move together along the at least one rail.

14. The machine of claim 1, further comprising a machine conveyer that is configured to deliver containers to the clamping mechanism.

15. The machine of claim 14, further comprising an ejector that is configured to eject containers from a line conveyor to the machine conveyor such that selected containers can be opened.

16. The machine of claim 1, further comprising a container opening apparatus that is configured to pivot a portion of cut containers so as to drain the contents of the containers.

17. The machine of claim 16, wherein the container opening apparatus is configured as a pivotable, counter-weighted apparatus.

18. The machine of claim 1, further comprising a container cleaning mechanism that is configured to rinse and dry opened containers.

19. The machine of claim 18, wherein the container cleaning mechanism comprises at least one nozzle that is configured to alternately spray water and air at the opened containers.

20. A box container opening machine, comprising:
a clamping mechanism that is configured to firmly clamp box containers such that portions of the containers are exposed, the clamping mechanism including first and second clamping members;
a machine conveyor configured to deliver the box containers to the clamping mechanism; and
a cutting mechanism including a blade that is oriented so as to transversely cut the box containers along their exposed portions while the containers are clamped by the clamping mechanism.

21. The machine of claim 20, wherein the first clamping member is stationary and the second clamping member is pivotable such that the second clamping member can be pivoted toward and away from the first clamping member.

22. The machine of claim 21, further comprising actuators that pivot the second clamping member, the actuators each including a cylinder and a piston rod that can be extended from and retracted into the cylinder.

23. The machine of claim 22, wherein the clamping mechanism includes a mechanism body and further comprising levers that link the actuators to the second clamping member, the actuators and the levers being pivotally mounted to the body.

24. The machine of claim 20, further comprising a carriage and at least one rail along which the carriage can travel, the clamping mechanism being fixedly mounted to the carriage so as to travel with the carriage along the at least one rail.

25. The machine of claim 24, further comprising a displacement mechanism that is configured to displace the carriage along the at least one rail.

26. The machine of claim 25, wherein the displacement mechanism comprises a cylinder having an internal magnetic piston that is magnetically coupled to the carriage such that when the piston is displaced within the cylinder under the force of a fluid, the piston and carriage move together along the at least one rail.

27. The machine of claim 20, further comprising a container opening apparatus that is configured to pivot a lower portion of cut box containers so as to drain the contents of the containers, the apparatus including a pivotable, counter-weighted fence.

28. The machine of claim 20, further comprising a container cleaning mechanism that is configured to rinse and dry opened box containers.

29. The machine of claim 28, wherein the container cleaning mechanism comprises at least one nozzle that is configured to alternately spray water and air at the opened box containers.

30. A box container opening machine, comprising:
a clamping mechanism that is configured to firmly clamp box containers such that portions of the containers are exposed;
a cutting mechanism including a blade that is oriented so as to transversely cut the box containers along their exposed portions while the containers are clamped by the clamping mechanism; and
a displacement mechanism that is configured to axially displace the clamping mechanism.

31. The machine of claim 30, further comprising a carriage and at least one rail along which the carriage can travel, the clamping mechanism being fixedly mounted to the carriage so as to travel with the carriage along the at least one rail.

32. The machine of claim 31, wherein the displacement mechanism comprises a cylinder having an internal magnetic piston that is magnetically coupled to the carriage such that when the piston is displaced within the cylinder under the force of a fluid, the piston and carriage move together along the at least one rail.

33. A clamping mechanism, comprising:
a mechanism body;
a first clamping member fixedly mounted to the mechanism body;
an actuator mounted to the mechanism body;
a lever pivotally connected to the actuator and to the mechanism body; and
a second clamping member connected to the lever so that the second clamping member is selectively pivotable using the actuator so as to pivot toward and away from the first clamping member.

34. The clamping mechanism of claim 33, wherein the actuator comprises a cylinder and a piston rod that can be extended from and retracted into the cylinder.

35. A method for facilitating inspection of a container, comprising:
diverting the container from a first conveyor to a container opening machine;
delivering the container to a container clamping mechanism;
clamping the container with the container clamping mechanism;
cutting the container open with a cutting mechanism while the container is clamped by the clamping mechanism; and
draining the container of its contents.

36. The method of claim 35, wherein the diverting step comprises diverting the container with an ejector.

37. The method of claim 35, wherein the delivering step comprises delivering the container with a conveyor of the container opening machine.

38. The method of claim 35, wherein the clamping step comprises clamping the container such that a substantial portion of the container is exposed.

39. The method of claim 35, wherein the cutting step comprises transversely cutting the container approximately in half.

40. The method of claim 35, wherein the draining step comprises pivoting a portion of the container to drain its contents.
